(19) United States
(12) Patent Application Publication
(10) Pub. No.: US 2017/0034827 A1
(43) Pub. Date: Feb. 2, 2017

(54) SENSOR INFORMATION WIRELESS TRANSMISSION DEVICE

(71) Applicant: Rohm Co., Ltd., Kyoto (JP)

(72) Inventors: Takashi NAIKI, Kyoto (JP); Satoshi SAKAIDANI, Kyoto (JP)

(21) Appl. No.: 15/203,950

(22) Filed: Jul. 7, 2016

(30) Foreign Application Priority Data
Jul. 28, 2015 (JP) 2015148897

(51) Int. Cl. H04W 72/04

(52) U.S. Cl. CPC H04W 72/0453; H04W 84/18

(57) ABSTRACT

A sensor information wireless transmission device has: a sensor; a converter that converts the output signal, which is a time-axis signal, of the sensor into a frequency-axis signal; an extractor that extracts from the frequency-axis signal an extraction signal spreading across a specific frequency range; and a communicator that wirelessly transmits the extraction signal.

This nonprovisional application claims priority under 35 U.S.C. §119(a) on Patent Application No. 2015-148897 filed in Japan on Jul. 28, 2015, the entire contents of which are hereby incorporated by reference.

### BACKGROUND OF THE INVENTION

1. Field of the Invention

The present invention relates to a sensor information wireless transmission device that wirelessly transmits sensor information corresponding to an output signal of a sensor.

2. Description of Related Art

One example of the application of a sensor information wireless transmission device that wirelessly transmits sensor information corresponding to an output signal of a sensor is health monitoring of constructed structures such as bridges, tunnels, and dams. There is conventionally proposed health monitoring of constructed structures that exploits sensor information corresponding to an output signal of a vibration sensor (see, e.g., Japanese Patent Application Publication No. 2013-122718).

Inconveniently, however, for one thing, improving the analysis precision of health monitoring requires the installation of a large number of vibration sensors (e.g., several tens to several hundred) on one constructed structure. For another thing, an output signal of a vibration sensor contains different frequency components, and thus contains a large amount of data. This results in a high wireless transmission load, requiring a large amount of electric power for wireless transmission.

### SUMMARY OF THE INVENTION

An object of the present invention is to provide a sensor information wireless transmission device that can operate with a reduced wireless transmission load, and to provide a sensor information transfer system incorporating such a sensor information wireless transmission device.

To achieve the above object, according to one aspect of the present invention, a sensor information wireless transmission device includes: a sensor; a converter that converts an output signal, which is a time-axis signal, of the sensor into a frequency-axis signal; an extractor that extracts from the frequency-axis signal an extraction signal spreading across a specific frequency range; and a communicator that wirelessly transmits the extraction signal.

To achieve the above object, according to another aspect of the present invention, a sensor information transfer system includes: a plurality of sensor information wireless transmission devices configured as described above; and an acquisition device that acquires extraction signals that are wirelessly transmitted from the plurality of sensor information wireless transmission devices respectively.

The significance and effect of the present invention will become clear from the description of embodiments that follows. It should however be understood that the embodiments disclosed herein are merely examples of how the present invention can be implemented, and that the meanings of the terms referring to various elements and features of the present invention are not limited to those in which those terms are used in the following description of embodiments.

### BRIEF DESCRIPTION OF THE DRAWINGS

FIG. 1 is a diagram showing a configuration of a sensor information wireless transmission device according to a first embodiment;

FIG. 2 is a diagram showing one illustrative configuration of an internal power supply;

FIG. 3 is a diagram showing another illustrative configuration of an internal power supply;

FIG. 4 is a diagram showing yet another illustrative configuration of an internal power supply;

FIG. 5 is a diagram showing an illustrative outline configuration of a bridge health monitoring system;

FIG. 6 is a diagram showing another illustrative outline configuration of a bridge health monitoring system;

FIG. 7 is a flow chart showing illustrative operation of a microcomputer; and

FIG. 8 is a diagram showing a configuration of a sensor information wireless transmission device according to a second embodiment.

### DETAILED DESCRIPTION OF PREFERRED EMBODIMENTS

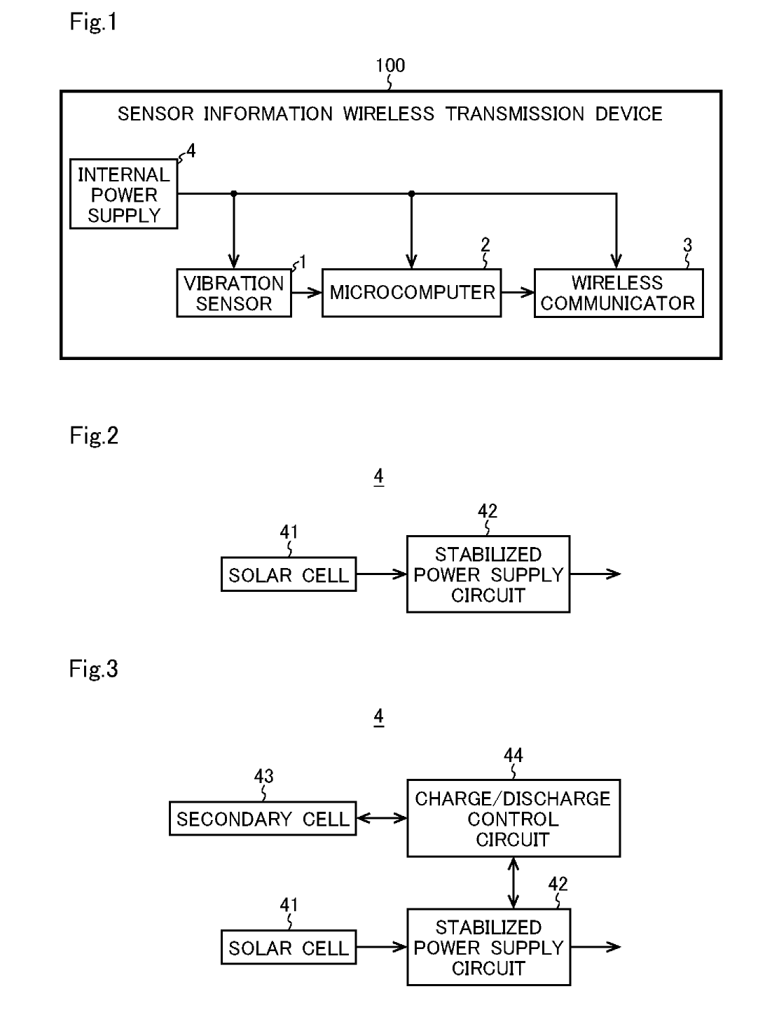

First Embodiment: FIG. 1 is a diagram showing a configuration of a sensor information wireless transmission device according to a first embodiment. The sensor information wireless transmission device 100 shown in FIG. 1 includes a vibration sensor 1, a microcomputer 2, a wireless communicator 3, and an internal power supply 4.

The vibration sensor 1 detects vibration that is generated by the ambience, and outputs a detection signal indicating it. As the vibration sensor 1, it is possible to use, for example, a sensor that detects vibration along one axis, or a sensor that detects vibration along three axes. In a case where a sensor that detects vibration along three axes is used as the vibration sensor 1, separate scalar quantities may be output as detection signals for the three axes respectively, or a vector quantity may be output as a detection signal.

Although FIG. 1 shows a configuration where only one vibration sensor 1 is provided, a plurality of vibration sensors 1 may be provided. In a case where a plurality of vibration sensors 1 are provided, a configuration is possible where, for example, three vibration sensors are provided, namely one for detecting vibration in the X-direction, one for detecting vibration in the Y-direction, and one for detecting vibration in the Z-direction. Here, the X-, Y-, and Z-axes refer to the reference axes in a rectangular coordinate system.

The vibration sensor 1 may be housed, along with the microcomputer 2, the wireless communicator 3, and the internal power supply 4, in a body of the sensor information wireless transmission device 100. Instead, the vibration sensor 1 may be housed outside a body of the sensor information wireless transmission device 100 in which the microcomputer 2, the wireless communicator 3, and the internal power supply 4 are housed, in which case the vibration sensor 1 can be connected to the microcomputer 2 on a wired basis.

The microcomputer 2 includes an A/D converter, a discrete Fourier converter, and a digital band-pass filter. The A/D converter performs A/D conversion on the output signal of the vibration sensor 1, which is a time-axis signal, a predetermined sampling number of times at a predetermined sampling frequency. The discrete Fourier converter performs discrete Fourier transform on the digital signal output from the A/D converter to produce a frequency-axis signal. The digital band-pass filter extracts from the frequency-axis signal output from the discrete Fourier converter an extraction signal spread across a specific frequency range. The operation of the microcomputer 2 will be described in detail later. The width of the specific frequency range is subject to no particular restriction. It is preferable that the width of the specific frequency range be variable. In a case where the width of the specific frequency range is variable, the width may be changed automatically according to at least one of the lower limit value, center value, and upper limit value of the specific frequency range; instead, an input means may be provided to allow entry of setting information on the width of the specific frequency range so that the user can change the width by operating the input means.

The wireless communicator 3 transmits the extraction signal output from the microcomputer 2 to the outside by high-frequency wireless communication such as Bluetooth (a registered trademark).

The internal power supply 4 supplies electric power to the vibration sensor 1, the microcomputer 2, and the wireless communicator 3.

FIG. 2 is a diagram showing an illustrative configuration of the internal power supply 4. In the illustrative configuration shown in FIG. 2, the internal power supply 4 includes a solar cell 41 and a stabilized power supply circuit 42. The solar cell 41 converts solar energy into electric power. The stabilized power supply circuit 42 converts the electric power output from the solar cell 41 into stabilized direct-current electric power, and supplies the stabilized direct-current electric power to the vibration sensor 1, the microcomputer 2, and the wireless communicator 3. The illustrative configuration in FIG. 2 requires no battery replacement, and thus helps realize a maintenance-free configuration.

FIG. 3 is a diagram showing another illustrative configuration of the internal power supply 4. In the illustrative configuration shown in FIG. 3, the internal power supply 4 includes, in addition to a solar cell 41 and a stabilized power supply circuit 42, a secondary cell 43 and a charge/discharge control circuit 44. The charge/discharge control circuit 44 controls the charging and discharging of the secondary cell 43. In this illustrative configuration, when the electric power generated by the solar cell 41 is high, the stabilized power supply circuit 42 supplies a surplus of electric power to the charge/discharge control circuit 44, which then supplies the surplus of electric power to the secondary cell 43. On the other hand, when the electric power generated by the solar cell 41 is low, the stabilized power supply circuit 42 communicates a shortage of electric power to the charge/discharge control circuit 44, which then compensates for the shortage of electric power by discharging the secondary cell 43 to supply electric power to the stabilized power supply circuit 42. With the illustrative configuration in FIG. 3, the sensor information wireless transmission device 100 can operate even in a period where the solar cell 41 is not generating electric power. Moreover, by appropriate choice of a secondary cell 43 that has a lifetime equal to or longer than that of the other components, it is possible to realize a substantially maintenance-free configuration.

Instead of the solar cell 41, any power harvesting device (environmental power generation device) other than a solar cell may be used. A power harvesting device other than a solar cell can be, for example, a bimorph, which is composed of two piezoelectric plates bonded together and which converts a displacement brought by an applied force (mechanical energy) into electric power, or a thermoelectric element, which converts thermal energy into electric power. The vibration sensor 1 may be configured to double as a power harvesting device. Although FIG. 2 shows a configuration where only one solar cell 41 is provided as a power harvesting device, a plurality of power harvesting devices may be provided. In a case where a plurality of power harvesting devices are provided, they may all be power harvesting devices of the same type, or may be power harvesting devices of different types.

Instead of the secondary cell 43, any power storage device other than a secondary cell may be used. A power storage device other than a secondary cell can be, for example, an electrical double-layer capacitor. For the internal power supply 4, which includes a power storage device, any configuration other than that shown in FIG. 3 may be adopted out of a variety of configurations based on different concepts. For example, in one of the simplest configurations, the electric power generated by a power harvesting device is first stored in a power storage device via a charge circuit (when the power storage device is in a fully charged state, the charge circuit discards the electric power generated by the power harvesting device); the electric power stored in the power storage device is eventually fed to the stabilized power supply circuit, which then supplies the electric power to different parts in the device.

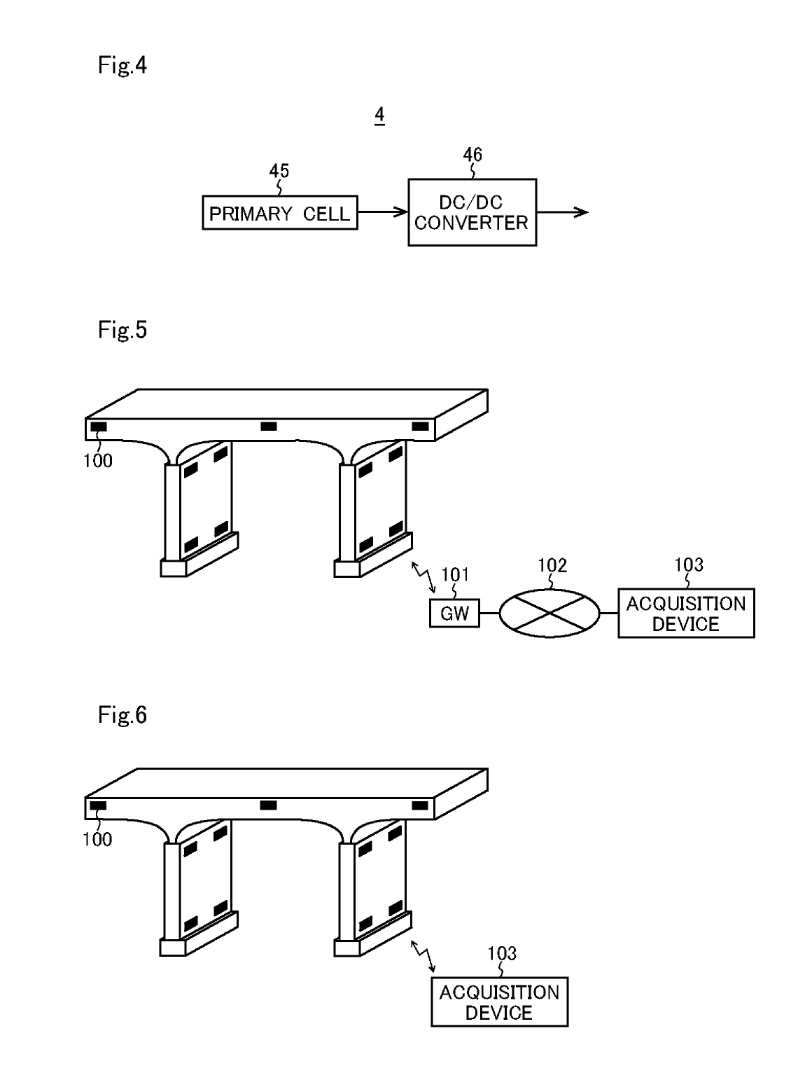

FIG. 4 is a diagram showing yet another illustrative configuration of the internal power supply 4. In the illustrative configuration shown in FIG. 4, the internal power supply 4 includes a primary cell 45 and a DC/DC converter 46. The DC/DC converter 46 converts the output voltage of the primary cell 45 into a stabilized direct-current voltage, and applies the stabilized direct-current voltage to the vibration sensor 1, the microcomputer 2, and the wireless communicator 3. With this illustrative configuration, by appropriate choice of a primary cell 45 that has a lifetime equal to or longer than that of the other components, it is possible to realize a substantially maintenance-free configuration.

FIG. 5 is a diagram showing an illustrative outline configuration of a health monitoring system for a bridge in which a sensor information wireless transmission device 100 is used. A bridge health monitoring system is merely one example of application of a sensor information wireless transmission device 100; the application of a sensor information wireless transmission device 100 is not limited to a bridge health monitoring system.

The bridge health monitoring system includes sensor information wireless transmission devices 100, a gateway (GW) 101 as a relay station, and an acquisition device 103, and is configured as a sensor information transfer system that transfers the extraction signals output from the individual sensor information wireless transmission devices 100 to the acquisition device 103. The acquisition device 103 analyzes the acquired extraction signals (sensor information) and thereby monitors for any sign of breakage or destruction of a bridge.

A large number of sensor information wireless transmission devices 100 are installed on a bridge. Although FIG. 5 shows eleven sensor information wireless transmission devices 100, this is not meant to limit the number of devices; as many sensor information wireless transmission devices 100 as there are measurement points necessary for bridge health monitoring can be prepared, and those sensor information wireless transmission devices 100 can be installed respectively at those measurement points necessary for bridge health monitoring.

The gateway 101 is installed inside the wireless communication area of the sensor information wireless transmission devices 100, and receives the extraction signals from the sensor information wireless transmission devices 100 on a wireless basis. The extraction signals are transferred from the gateway 101 to the acquisition device 103 via a communication network 102. The communication network 102 can be a wired or wireless network, and can be a network of which part is wired and the rest is wireless. Although FIG. 5 shows only one gateway 101, a plurality of gateways 101 may be installed as necessary with consideration given to the number of sensor information wireless transmission devices 100 and their wireless communication area.

As in the illustrative outline configuration shown in FIG. 6, the gateway may be omitted, in which case the extraction signals can be transferred from the sensor information wireless transmission devices 100 to the acquisition device 103 directly by wireless communication.

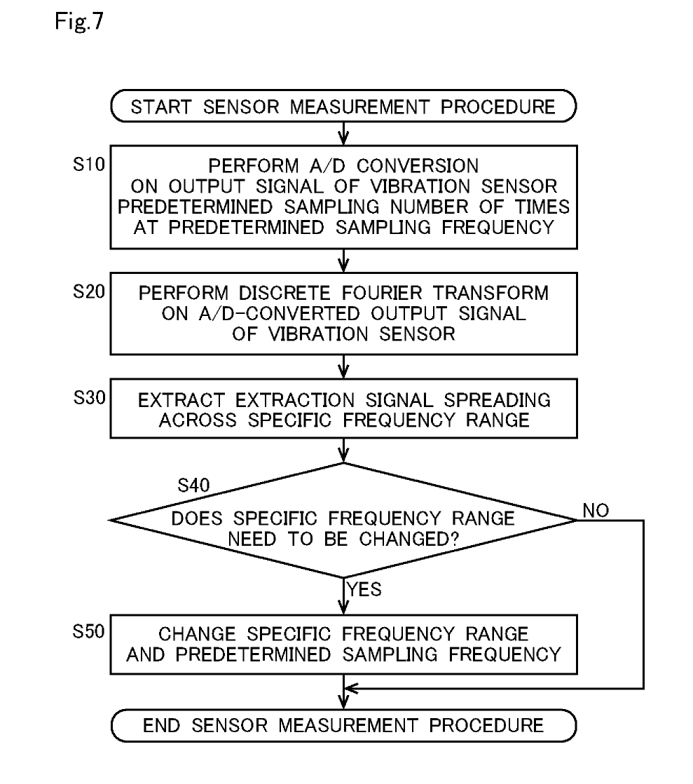

Next, with reference to FIG. 7, an illustrative operation of the microcomputer 2 will be described. The microcomputer 2 has a timer function which it uses to execute a sensor measurement procedure periodically (e.g., every twelve hours).

On starting the sensor measurement procedure, the microcomputer 2 first performs A/D conversion on the output signal of the vibration sensor 1 a predetermined sampling number of times at a predetermined sampling frequency (Step S10).

Next, the microcomputer 2 performs discrete Fourier transform on the output signal of the vibration sensor 1 after the A/D conversion to produce a frequency-axis signal (Step S20).

Next, the microcomputer 2 extracts from the frequency-axis signal an extraction signal that is spread across a specific frequency range, and outputs the extracted extraction signal to the wireless communicator 3 (Step S30).

Next, the microcomputer 2 checks whether or not the specific frequency range needs to be changed (Step S40). The behavior of a sensor measurement target differs depending on where the sensor information wireless transmission device 100 is installed. The behavior of the sensor measurement target also varies with the degree of deterioration of the bridge on which the sensor information wireless transmission device 100 is installed, and with the environmental conditions around the sensor information wireless transmission device 100. As the behavior of the sensor measurement target varies, the optimum setting of the specific frequency range can vary.

Here, consider a case where the A/D conversion at Step S10 is performed a sufficient sampling number of times at a sampling frequency that yields sufficient resolution, where the discrete Fourier transform at Step S20 is performed with sufficient precision, and where the extraction process at Step S30 is omitted. In this case, when, while the amplitude of the sensor measurement target remains constant, its characteristic frequency alone varies, there will probably be almost no decrease in the peak value of the frequency-axis signal that results from the discrete Fourier transfer at Step S20. Thus, the checking process at Step S40, which is described above, and the changing process at Step S50, which will be described later, are unnecessary. However, this configuration, where the A/D conversion at Step S10 is performed a sufficient sampling number of times at a sampling frequency that yields sufficient resolution, where the discrete Fourier transform at Step S20 is performed with sufficient precision, and where the extraction process at Step S30 is omitted, is disadvantageous in making the sensor information wireless transmission device expensive and increasing the wireless transmission load.

Now, consider a case where, to achieve an inexpensive configuration, the A/D conversion at Step S10 is performed a limited sampling number of times at a limited sampling frequency, where the discrete Fourier transform at Step S20 is performed with low precision, and where, to reduce the wireless transmission load, the extraction process at Step S30 is executed. In this case, even when, while the amplitude of the sensor measurement target remains constant, its characteristic frequency alone varies, the characteristic frequency of the sensor measurement target deviates from the center frequency of the specific frequency range which is the frequency range of the extraction signal extracted at Step S30, resulting in a decrease in the peak value of the extraction signal extracted at Step S30. This requires review (re-adjustment) of the specific frequency range which is the frequency range of the extraction signal extracted at Step S30. Thus, it is preferable to check whether or not the specific frequency range needs to be changed as in this embodiment. The check can be implemented, roughly, either as an autonomous check or as a heteronomous check.

Examples of autonomous checks will now be described.

Autonomous Check, First Example: When a sensor information wireless transmission device 100 has just been installed, the optimum setting of the specific frequency range, which differs depending on the installation spot, is unknown. Thus, the microcomputer 2 judges that the specific frequency range needs to be changed. Whether or not the sensor information wireless transmission device 100 has been installed can be recognized, for example, by one of the following methods. According to one method, a means for checking whether or not the sensor information wireless transmission device 100 has been started up for the first time is provided so that, when the means is started up for the first time, the device 100 is recognized to have been installed. According to another method, an input means, such as a key dedicated to flagging completion of installation, is provided so that, when a user operates the input means on completion of installation, the installation is recognized as a result of the operation. When the sensor information wireless transmission device 100 is installed, it is necessary to sweep the entire frequency band of the frequency-axis signal to determine the optimum setting of the specific frequency range. For example, in the just-mentioned sweeping, a specific frequency range in which the extraction signal has the highest peak can be taken as the optimum setting of the specific frequency range. Preferably, to complete the sweeping in a short period, after the process at Step S50, which will be described later, a return is made to Step S10 so that, until the sweeping is completed, a loop is run in which, after the process at Step S50, a return is made to Step S10.

Autonomous Check, Second Example: When a decrease in the peak value of the extraction signal is detected, the microcomputer 2 judges that the specific frequency range needs to be changed. A decrease in the peak value of the extraction signal can be detected, for example, by one of the following methods. According to one method, when the peak value of the extraction signal this time is a predetermined proportion (e.g., 20%) or more less than the average peak value of the extraction signal for the last n times (where n is a natural number), a decrease in the peak value of the extraction signal is recognized. According to another method, when the peak value of the extraction signal this time exhibits a decrease equal to or larger than a predetermined value from the average peak value of the extraction signal for the last n times (where n is a natural number), a decrease in the peak value of the extraction signal is recognized.

Autonomous Check, Third Example: In the second example above, when a decrease in the peak value of the extraction signal is detected, the specific frequency range is changed. However, if the amount by which the specific frequency range is changed is not equivalent to the amount by which the frequency corresponding to the peak value of the extraction signal is shifted, that is, if the amount of shift in the frequency corresponding to the peak value of the extraction signal is extremely large, the setting of the specific frequency range may deviates from the optimum setting.

To avoid that, in the third example, the microcomputer 2 reviews the specific frequency range periodically (e.g., every week) by use of the timer function. The reviewing is performed by a method similar to that by which the optimum setting of the specific frequency range is checked in the first example described above. The specific frequency range is reviewed based on the peak value of the extraction signal by sweeping the entire frequency band of the frequency-axis signal, and this is tantamount to reviewing the specific frequency range based on the frequency-axis signal.

Heteronomous Check, First Example: When the installation of a sensor information wireless transmission device 100 is completed, the acquisition device 103 outputs a control signal that instructs to sweep the entire frequency band of the frequency-axis signal to check the optimum setting of the specific frequency range. This control signal is sent via the communication network 102 and the gateway 101, or directly, to the wireless communicator 3 of the sensor information wireless transmission device 100, and is received by the wireless communicator 3. According to the control signal received by the wireless communicator 3, the microcomputer 2 sweeps the entire frequency band of the frequency-axis signal to check the optimum setting of the specific frequency range. The optimum setting of the specific frequency range is checked by a method similar to that described above under Autonomous Check, Example 1.

Heteronomous Check, Second Example: The acquisition device 103 acquires extraction signals from a plurality of sensor information wireless transmission devices 100. Thus, the acquisition device 103 may change the specific frequency range in one sensor information wireless transmission device 100 on the basis of the extraction signal transmitted from another sensor information wireless transmission device 100 installed in the neighborhood of the one sensor information wireless transmission device 100. For example, when the peak of the extraction signal transmitted from one sensor information wireless transmission device 100 is smaller than the peak of the extraction signal transmitted from another sensor information wireless transmission device 100 installed in the neighborhood of the one sensor information wireless transmission device 100, the acquisition device 103 outputs a control signal instructing to change the specific frequency range to the one sensor information wireless transmission device 100.

Here, whether or not the peak of the extraction signal transmitted from one sensor information wireless transmission device 100 is smaller than the peak of the extraction signal transmitted from another sensor information wireless transmission device 100 installed in the neighborhood of the one sensor information wireless transmission device 100 can be detected, for example, by one of the methods described below.

According to a first detection method, when the peak of the extraction signal of one sensor information wireless transmission device 100 as a target is a predetermined proportion (e.g., 20%) or more smaller than the average peak value of the extraction signals of the sensor information wireless transmission devices 100 that are the nearest and the second nearest to the one sensor information wireless transmission device 100 as the target, the peak of the extraction signal of the one sensor information wireless transmission device 100 is detected being smaller than the peaks of the extraction signals of sensor information wireless transmission devices 100 installed in the neighborhood of the one sensor information wireless transmission device 100.

According to a second detection method, when the peak of the extraction signal of one sensor information wireless transmission device 100 as a target is a predetermined value or more smaller than the average peak value of the extraction signals of the sensor information wireless transmission devices 100 that are the nearest and the second nearest to the one sensor information wireless transmission device 100 as the target, the peak of the extraction signal of the one sensor information wireless transmission device 100 is detected being smaller than the peaks of the extraction signals of sensor information wireless transmission devices 100 installed in the neighborhood of the one sensor information wireless transmission device 100.

Heteronomous Check, Third Example: In this example, the acquisition device 103 has a timer function, and outputs, periodically (e.g., every week) by use of the timer function, a control signal instructing to review the specific frequency range to the sensor information wireless transmission device 100. The reviewing is performed by a method similar to that, described above under Autonomous Check, Example 1, for checking the optimum setting of the specific frequency range.

Heteronomous Check, Fourth Example: The acquisition device 103 acquires extraction signals from a plurality of sensor information wireless transmission devices 100. Thus, based on, for example, the results of an analysis of acquired extraction signals, the acquisition device 103 determines in what frequency range to make each sensor information wireless transmission device 100 extract the extraction signal in order to obtain optimum data in the entire bridge health monitoring system. Based on the result of the determination, the acquisition device 103 feeds each sensor information wireless transmission device 100 with a control signal specifying the frequency range in which the sensor information wireless transmission device 100 should extract the extraction signal.

Heteronomous Check, Modified Example: In the above-described first to fourth examples of heteronomous checks, the acquisition device 103 itself specifies a specific frequency range to a sensor information wireless transmission devices 100. In response, the acquisition device 103 acquires an extraction signals in the specific frequency range. Thus, by studying if the acquired extraction signal, which is supposed to be in the specific frequency range, does fall within the specific frequency range as specified, it is possible to check for a fault such as communication failure.

Now, with reference back to FIG. 7, the procedure after the checking process at Step S40 will be described.

If, in the checking process at Step S40, it is judged that the specific frequency range does not need to be changed (Step S40, NO), the changing process at Step S50 is skipped, and the sensor measurement procedure is ended.

On the other hand, if, in the checking process at Step S40, it is judged that the specific frequency range needs to be changed (Step S40, YES), the microcomputer 2 changes the specific frequency range, and changes the predetermined sampling frequency for A/D conversion in accordance with the changed specific frequency range (Step S50). For example, the predetermined sampling frequency for A/D conversion can be made equal to a constant value times the frequency corresponding to the peak of the extraction signal. Thus, unless the frequency corresponding to the peak of the extraction signal in the extraction of the extraction signal next time deviates from the frequency corresponding to the peak of the extraction signal in the extraction of the extraction signal this time, an extraction signal with a clean peak is extracted in the extraction of the extraction signal next time. Instead of the predetermined sampling frequency for A/D conversion or in addition to it, the predetermined sampling number of times for A/D conversion may be changed according to the specific frequency range.

In the flow chart shown in FIG. 7, the sensor measurement procedure is ended after the completion of the changing process at Step S50. This is because there is no urgency to instantaneously reflect the changing process at Step S50 in the sensor measurement procedure. Thus, the changing process at Step S50 is reflected in the next session of sensor measurement. Unlike the flow chart shown in FIG. 7, a return can be made to Step S10 after the completion of the process at Step S50 so that sensor measurement is started over without waiting for the next session of sensor measurement.

With the sensor information wireless transmission device 100 described above, it is not necessary to perform the A/D conversion at Step S10 a sufficient number of sampling times at a sampling frequency that yields sufficient resolution, nor is it necessary to perform the discrete Fourier transform at Step S20 with sufficient precision. It is thus possible to adopt an inexpensive configuration and thereby suppress introduction cost.

With the sensor information wireless transmission device 100 described above, the extraction signal is transmitted wirelessly, and this helps reduce the amount of data transmitted wirelessly (the wireless transmission load). It is thus possible to suppress the electric power required for wireless transmission, and thereby to suppress the running cost of the sensor information wireless transmission device 100.

As described above, the sensor information wireless transmission device 100 helps suppress both introduction cost and running cost, and contributes to a wide spread of such devices.

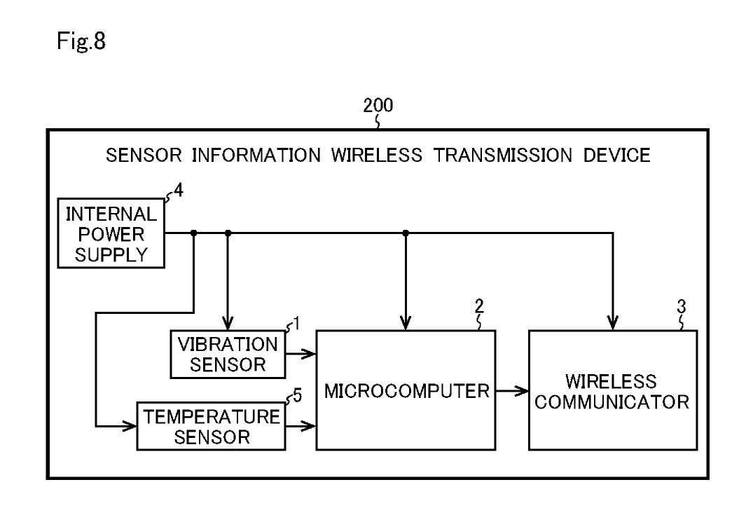

Second Embodiment: FIG. 8 is a diagram showing a configuration of a sensor information wireless transmission device according to a second embodiment. The sensor information wireless transmission device 200 shown in FIG. 8 additionally includes a temperature sensor 5 as compared with the sensor information wireless transmission device 100. A bridge health monitoring system that is built by use of the sensor information wireless transmission device 200 has a system configuration similar to the illustrative configurations shown in FIGS. 5 and 6.

The vibration characteristics of a bridge can depend greatly on temperature. Accordingly, in this embodiment, so that the specific frequency range can be set optimally even in a case where the vibration characteristics of a bridge depends greatly on temperature, the output of the temperature sensor 5 is referred to. Specifically, when the temperature detected by the temperature sensor 5 changes greatly, at Step S40 in FIG. 7, the microcomputer 2 judges that the specific frequency range needs to be changed. For example, when the temperature detected by the temperature sensor 5 this time exhibits a variation equal to or larger than a predetermined value from the average temperature detected by the temperature sensor 5 for the last n times (where in is a natural number), the temperature detected by the temperature sensor 5 is detected having changed greatly.

Whether or not the temperature detected by the temperature sensor 5 has changed greatly may be determined by the microcomputer 2, or information on the output of the temperature sensor 5 may be transferred from the sensor information wireless transmission device 200 to the acquisition device 103 so that the acquisition device 103 makes the determination. In a case where whether or not the temperature detected by the temperature sensor 5 has changed greatly is determined by the microcomputer 2, whether or not the specific frequency range needs to be changed is checked autonomously. On the other hand, in a case where whether or not the temperature detected by the temperature sensor 5 has changed greatly is determined by the acquisition device 103, whether or not the specific frequency range needs to be changed is checked heteronomously.

In a case where there is a strong correlation between the temperature detected by the temperature sensor 5 and the date and time, at Step S40 shown in FIG. 7, whether or not the specific frequency range needs to be changed may be checked, instead of by using the output of the temperature sensor 5, based on the date and time acquired by calendar and clock functions that can be additionally provided.

Other Modifications: The present invention may be implemented in any other manner than in the embodiments specifically described above, and allows for many modifications and variations within the spirit of the invention.

For example, although, in the above embodiments, the sensor information wireless transmission device wirelessly transmits sensor information corresponding to the output signal of a vibration sensor, it may instead transmit, for example, sensor information corresponding to the output signal of an acoustic sensor. With a configuration that processes the output signal of a sensor that, like the output signal of a vibration sensor, contains different frequency components, it is possible to reduce the wireless communication load by wirelessly transmitting an extraction signal spreading across a specific frequency range.

Thus, it should be understood that the above embodiments are in every aspect illustrative and not restrictive; it should also be understood that the technical scope of the present invention is defined not by the description of the embodiments given above but by the appended claims, and encompasses any modifications in a scope and sense equivalent to those of the claims.

Synopsis: According to one aspect of what is disclosed herein, a sensor information wireless transmission device includes: a sensor; a converter that converts an output signal, which is a time-axis signal, of the sensor into a frequency-axis signal; an extractor that extracts from the frequency-axis signal an extraction signal spreading across a specific frequency range; and a communicator that wirelessly transmits the extraction signal (a first configuration).

In the sensor information wireless transmission device according to the first configuration described above, the specific frequency range may be variable (a second configuration).

In the sensor information wireless transmission device according to the second configuration described above, the converter may acquire the output signal of the sensor a predetermined sampling number of times at a predetermined sampling frequency, and as the specific frequency range is varied, at least one of the predetermined sampling number of times or the predetermined sampling frequency may be changed (a third configuration).

In the sensor information wireless transmission device according to the second or third configuration described above, the extractor may vary the specific frequency range in accordance with the extraction signal (fourth configuration).

In the sensor information wireless transmission device according to the second or third configuration described above, on detecting a decrease in the peak value of the extraction signal, the extractor may vary the specific frequency range (a fifth configuration).

In the sensor information wireless transmission device according to the second or third configuration described above, there may be further provided a temperature sensor as a sensor separate from the sensor, and the extractor may vary the specific frequency range in accordance with an output of the temperature sensor (a sixth configuration).

In the sensor information wireless transmission device according to the second or third configuration described above, the communicator may receive a control signal from the outside, and the extractor may vary the specific frequency range in accordance with the control signal (a seventh configuration).

In the sensor information wireless transmission device according to any one of the second to seventh configurations described above, the extractor may review the specific frequency range periodically based on the frequency-axis signal (an eighth configuration).

In the sensor information wireless transmission device according to any one of the first to eighth configurations described above, there may be further provided a power harvesting device (a ninth configuration).

According to another aspect of what is disclosed herein, a sensor information transfer system includes: a plurality of sensor information wireless transmission devices according to any one of the first to ninth configurations described above; and an acquisition device that acquires extraction signals that are wirelessly transmitted from the plurality of sensor information wireless transmission devices respectively (a tenth configuration).

What is claimed is:

1. A sensor information wireless transmission device, comprising:
a sensor;
a converter that converts an output signal, which is a time-axis signal, of the sensor into a frequency-axis signal;
an extractor that extracts from the frequency-axis signal an extraction signal spreading across a specific frequency range; and
a communicator that wirelessly transmits the extraction signal.

2. The sensor information wireless transmission device of claim 1, wherein
the specific frequency range is variable.

3. The sensor information wireless transmission device of claim 2, wherein
the converter acquires the output signal of the sensor a predetermined sampling number of times at a predetermined sampling frequency, and
as the specific frequency range is varied, at least one of the predetermined sampling number of times or the predetermined sampling frequency is changed.

4. The sensor information wireless transmission device of claim 2, wherein
the extractor varies the specific frequency range in accordance with the extraction signal.

5. The sensor information wireless transmission device of claim 4, wherein
an entire frequency band of the frequency-axis signal is swept.

6. The sensor information wireless transmission device of claim 5, wherein
the entire frequency band of the frequency-axis signal is swept to check an optimum setting of the specific frequency range.

7. The sensor information wireless transmission device of claim 4, wherein
on detecting a decrease in a peak value of the extraction signal, the extractor varies the specific frequency range.

8. The sensor information wireless transmission device of claim 2, further comprising:
a temperature sensor as a sensor separate from the sensor, wherein
the extractor varies the specific frequency range in accordance with an output of the temperature sensor.

9. The sensor information wireless transmission device of claim 2, wherein
the communicator receives a control signal from outside, and
the extractor varies the specific frequency range in accordance with the control signal.

10. The sensor information wireless transmission device of claim 2, wherein
the extractor reviews the specific frequency range periodically based on the frequency-axis signal.

11. The sensor information wireless transmission device of claim 1, further comprising:
a power harvesting device.

12. A sensor information transfer system, comprising:
a plurality of sensor information wireless transmission devices according to claim 1; and
an acquisition device that acquires extraction signals that are wirelessly transmitted from the plurality of sensor information wireless transmission devices respectively.

13. A sensor information transfer system, comprising:
a plurality of sensor information wireless transmission devices according to claim 9; and
an acquisition device that acquires extraction signals that are wirelessly transmitted from the plurality of sensor information wireless transmission devices respectively, wherein
the acquisition device transmits the control signal to the communicator.

14. The sensor information transfer system of claim 13, wherein
the specific frequency range in one sensor information wireless transmission device is varied based on the extraction signal transmitted from another sensor information wireless transmission device installed in a neighbor of the one sensor information wireless transmission device.

15. The sensor information transfer system of claim 13, wherein
the control signal is a control signal that instructs to review the specific frequency range periodically.

16. The sensor information transfer system of claim 13, wherein
the acquisition device determines content of the control signal based on a result of analysis of the extraction signal.
